(19) United States
(12) Patent Application Publication
(10) Pub. No.: US 2017/0271933 A1
(43) Pub. Date: Sep. 21, 2017

(54) AXIAL FLUX MOTOR HAVING MODULAR STATORS

(71) Applicant: BIGBEST SOLUTIONS, INC., Taichung City (TW)

(72) Inventors: Chia-Hung Hsu, Changhua County (TW); Ray-Min Chen, Hsinchu County (TW)

(73) Assignee: BIGBEST SOLUTIONS, INC., Taichung City (TW)

(21) Appl. No.: 15/440,253

(22) Filed: Feb. 23, 2017

(30) Foreign Application Priority Data
Mar. 15, 2016 (TW) 105107862

(51) Int. Cl. H02K 1/27; H02K 3/18; H02K 1/14

(52) U.S. Cl. CPC H02K 1/2793; H02K 1/14; H02K 3/18

(57) ABSTRACT

An axial flux motor includes a rotor and a plurality of stators. The stators are disposed around the rotor. Each stator includes a magnetic modular body, and a winding. The magnetic modular body includes a magnetic base and a top magnetic member. The magnetic base has an armature core surrounded by the winding, and a first connecting portion disposed on the armature core. The top magnetic member has a second magnetic face, and a second connecting portion that is disposed on the second magnetic face and that engages complementarily to the first connecting portion. The top magnetic member is connected to the armature core through an inter-engagement of the first and second connecting portions.

### CROSS-REFERENCE TO RELATED APPLICATION

This application claims priority to Taiwanese Patent Application No. 105107862, filed on Mar. 15, 2016.

### FIELD

The disclosure relates to an axial flux motor, and more particularly to an axial flux motor having modular stators.

### BACKGROUND

Referring to FIG. 1, a conventional axial flux motor includes a rotor 310 that is rotatable about an axis (Lx) and that includes a plurality of magnets 311, and a plurality of stators 320 disposed around a circumferential periphery of the rotor 310. Each stator 320 has a U-shaped magnetic body 321, and a winding 322 capable of inducing the magnetic body 321 to generate a magnetic force when an excitation current passes through the winding 322. Accordingly, the rotor 310 is driven to rotate by magnetic interaction between the magnets 311 and the stators 320.

In addition, the output power of the conventional axial flux motor is proportional to the winding number of the winding 322 in each of the stators 320 arranged around the circumferential periphery of the rotor 310. However, because an air gap between the magnetic body 321 of each stator 320 and the rotor 310 cannot be enlarged, and the space available for disposing the winding 322 is small, difficulties are encountered during the process of winding the wire of the winding 322 around the magnetic body 321. In addition, the small available space imposes substantial limitation on the number of turns and the winding density of the winding 322, thereby reducing the output power of the conventional axial flux motor.

### SUMMARY

Therefore, an object of the present disclosure is to provide an axial flux motor having modular stators that can alleviate the aforesaid drawback of the prior art.

According to the present disclosure, an axial flux motor includes a rotor and a plurality of stators.

The rotor includes a rotary body rotatable about an axis.

The stators are disposed around a circumferential periphery of the rotary body. Each of the stators includes a magnetic modular body and a winding. The magnetic modular body includes a magnetic base and a top magnetic member. The magnetic base has a first magnetic face, an armature core that is disposed on the first magnetic face and that is surrounded by the winding, and a first connecting portion disposed on top of the armature core. The top magnetic member has a second magnetic face, and a second connecting portion that is disposed on the second magnetic face and that engages complementarily to the first connecting portion. The top magnetic member is connected to the armature core through an inter-engagement of the first and second connecting portions. The first and second magnetic faces confront each other and cooperatively define a recess to allow the circumferential periphery of the rotary body to pass through when the rotary body rotates about the axis.

### BRIEF DESCRIPTION OF THE DRAWINGS

Other features and advantages of the disclosure will become apparent in the following detailed description of the embodiments with reference to the accompanying drawings, of which:

FIG. 1 is a partly exploded perspective view illustrating a rotor and stators of a conventional axial flux motor;

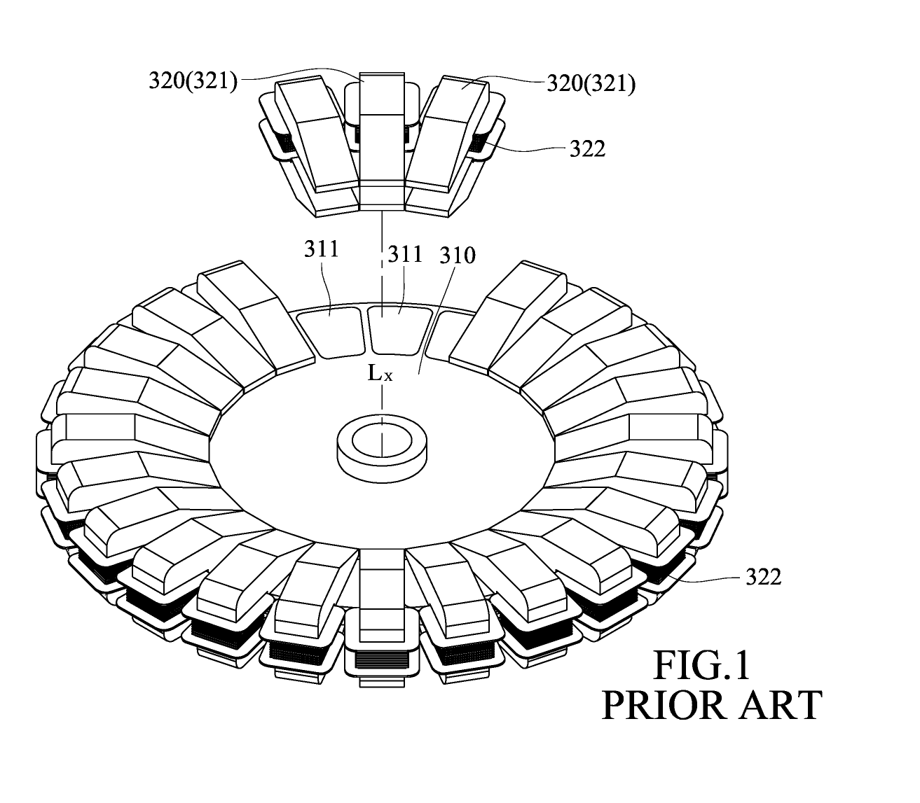

FIG. 2 is a perspective view illustrating a rotor and stators of an axial flux motor according to a first embodiment of the present disclosure;

FIG. 3 is a partly exploded perspective view of the first embodiment;

FIG. 4 is a perspective view illustrating one of the stators according to the first embodiment;

FIG. 5 is a side view of the stator of FIG. 4;

FIG. 6 is an exploded view of the stator of FIG. 4;

FIG. 7 is an exploded view illustrating a stator according to a second embodiment of the present disclosure;

FIG. 8 is side view of the stator of FIG. 7;

FIG. 9 is an exploded view of the stator of FIG. 7; and

FIG. 10 is a flow diagram showing a sequence of process steps for assembling the stator of the present disclosure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

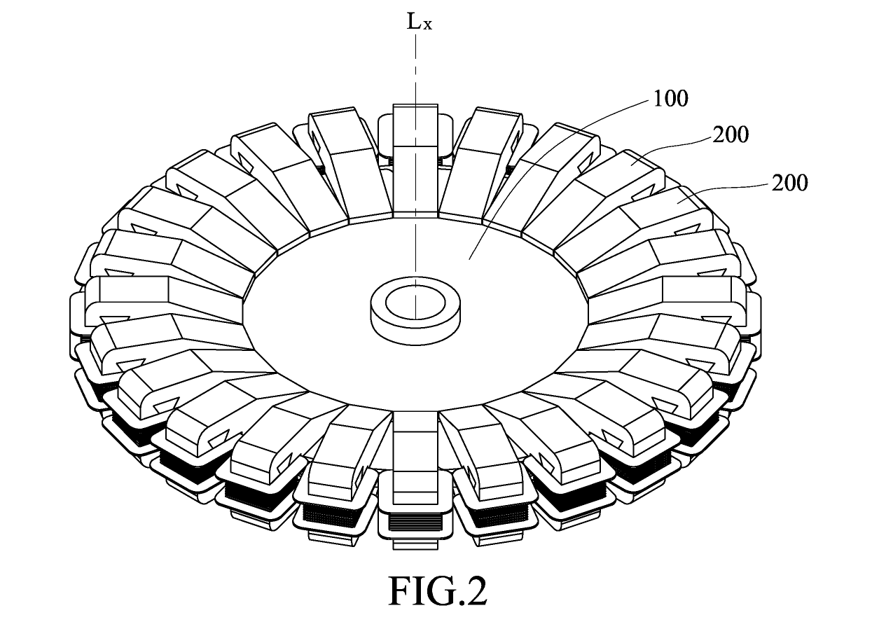

Referring to FIG. 2, an axial flux motor according to a first embodiment of the present disclosure includes a rotor 100 and a plurality of stators 200.

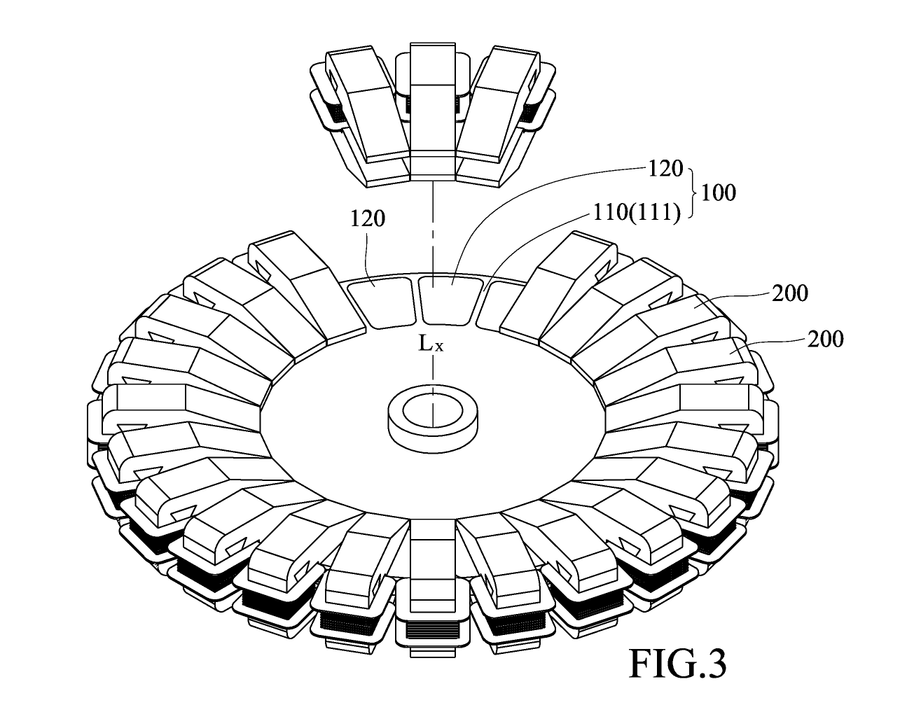

Referring to FIG. 3, the rotor 100 includes a rotary body 110 that is rotatable about an axis (Lx) and that has a circumferential periphery 111, and a plurality of spaced-apart magnets 120 that are disposed equiangularly about the axis (Lx) and on the circumferential periphery 111.

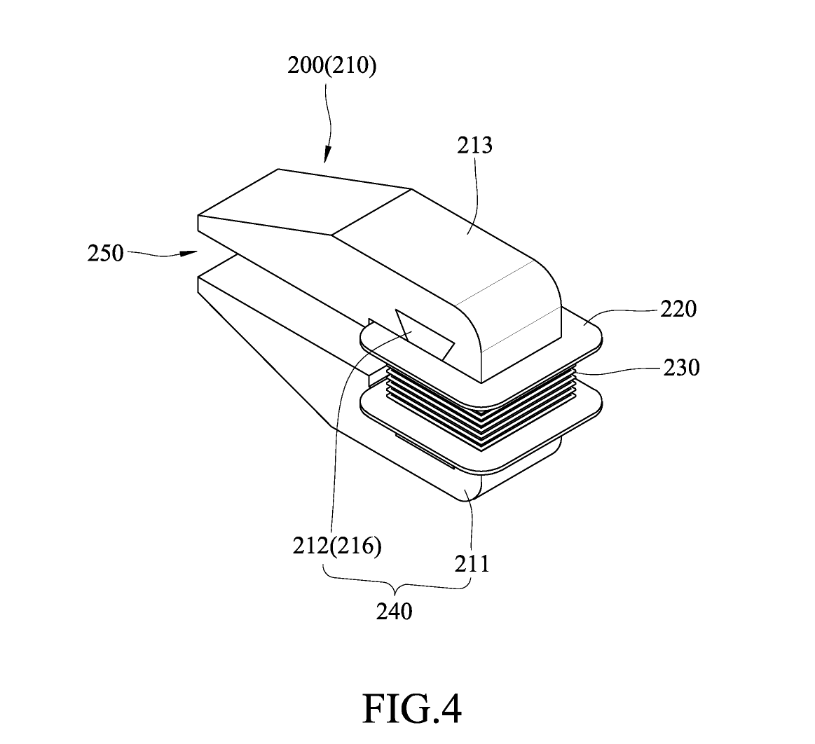

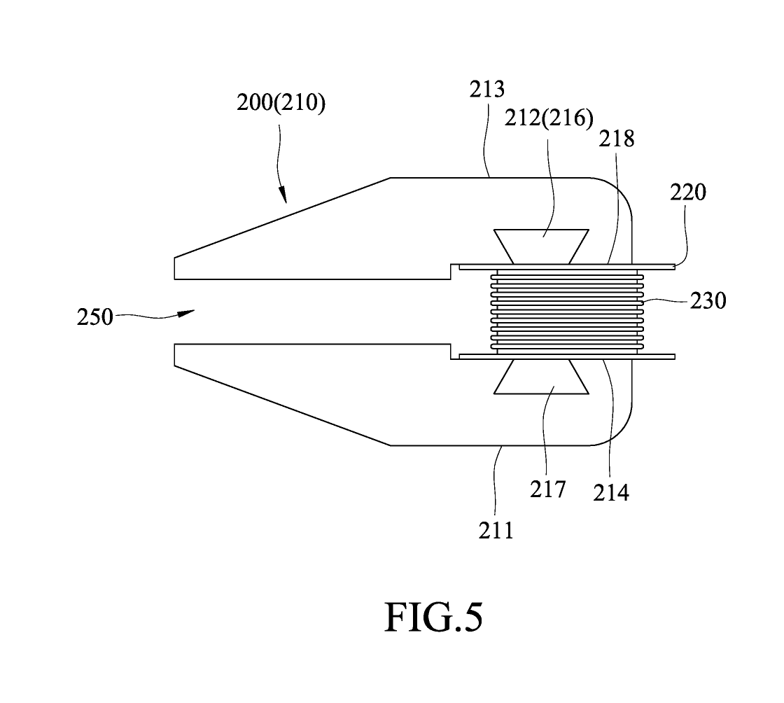

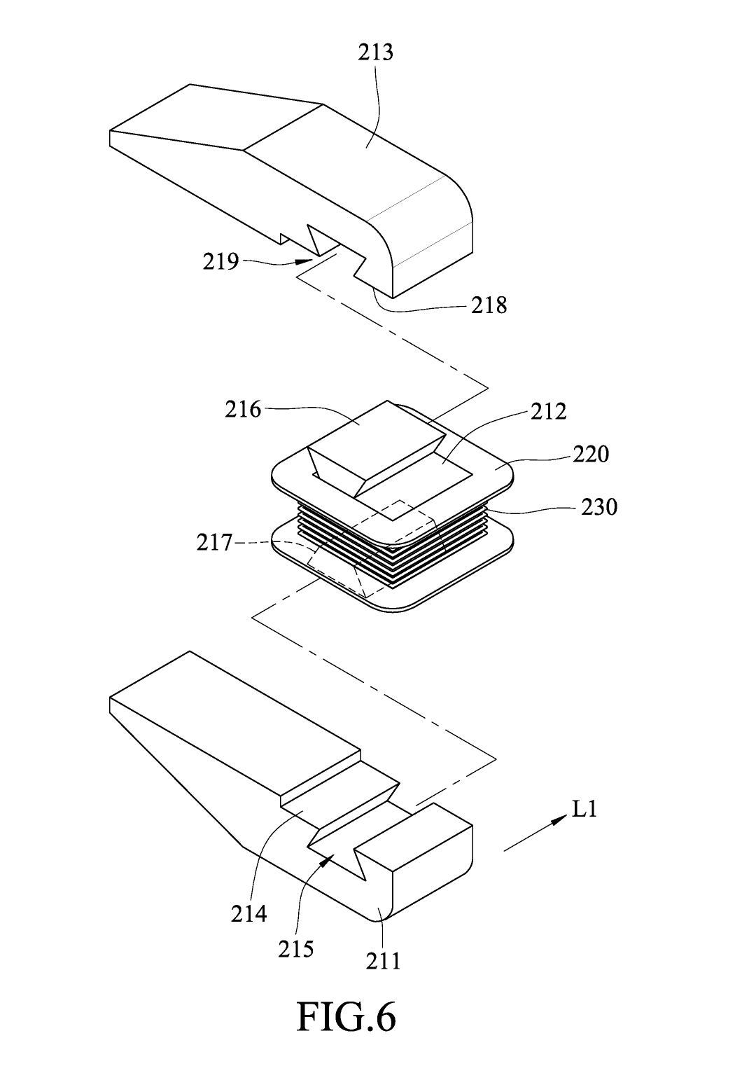

Referring to FIG. 4, in combination with FIG. 3, the stators 200 are disposed around the circumferential periphery 111. Each stator 200 includes a magnetic modular body 210, a winding holder 220 and a winding 230. Referring to FIGS. 5 and 6, the magnetic modular body 210 includes a bottom magnetic member 211, an armature core 212, and a top magnetic member 213. The term “magnetic base” used herein refers to a combination of the bottom magnetic member 211 and the armature core 212, which is denoted by numeral 240 in FIG. 4.

In this embodiment, the bottom magnetic member 211 and the armature core 212 are separate pieces so that the magnetic base 240 is a modular structure. The bottom magnetic member 211 has a top face formed as a first magnetic face 214. The armature core 212 is installed on the first magnetic face 214, and a first connecting portion 216 is disposed on top of the armature core 212. The winding holder 220 is sleeved on the armature core 212, and the winding 230 is wound on the winding holder 220. A third connecting portion 217 is disposed on bottom of the armature core 212. The bottom magnetic member 211 has a fourth connecting portion 215 that is disposed on the first magnetic face 214 and that engages complementarily the third connecting portion 217. The armature core 212 is connected to the bottom magnetic member 211 through an inter-engagement of the third and fourth connecting portions 217, 215.

The top magnetic member 213 has a second magnetic face 218, and a second connecting portion 219 that is disposed on the second magnetic face 218 and that engages complementarily to the first connecting portion 216. The top magnetic member 213 is connected to the armature core 212 through the inter-engagement of the first and second connecting portions 216, 219. The first and second magnetic faces 214, 218 confront each other and cooperatively define a recess 250 to allow the circumferential periphery 111 of the rotary body 110 to pass through when the rotary body 110 rotates about the axis (Lx).

In this embodiment, each of the top and bottom magnetic members 213, 211 and the armature core 212 is a one-piece molded magnetic block formed by a casting or machining process from a magnetic material, such as steel or iron. Alternatively, each of the top and bottom magnetic members 213, 211 and the armature core 212 may be a block composed of a plurality of laminated magnetic thin plates, such as silicon steel plates or iron plates, that are stacked along a first direction (L1).

In order to firmly assemble the top and bottom magnetic members 213, 211 and the armature core 212 and to resist bending moments produced at the connections between the top magnetic member 213 and the armature core 212 and between the bottom magnetic member 211 and the armature core 212, dovetail joints are used in the present disclosure. In this embodiment, the first connecting portion 216 is a trapezoidal tongue that extends along the first direction (L1) and that has a trapezoidal cross section which is transverse to the first direction (L1) and which is widened upward and narrowed downward. The second connecting portion 219 is a trapezoidal groove that extends along the first direction (L1). The third connecting portion 217 is a trapezoidal tongue that extends along the first direction (L1) and that has a trapezoidal cross section which is transverse to the first direction (L1) and which is narrowed upward and widened downward. The fourth connecting portion 215 is a trapezoidal groove that extends along the first direction (L1). The third connecting portion 217 is inserted into the fourth connecting portion 215 along the first direction (L1) to interengage each other and to assemble the armature core 212 on the bottom magnetic member 211. The first connecting portion 216 is inserted into the second connecting portion 219 along the first direction (L1) to interengage each other and to assemble the armature core 212 and the top magnetic member 213. As such, assembly of the magnetic modular body 210 is completed.

Besides the trapezoidal shape, the tongue and groove used for the first connecting portion 216 and the second connecting portion 219, and the tongue and groove used for the third connecting portion 217 and the fourth connecting portion 215 may also have a T-shaped cross-section.

The winding 230 may be assembled on the armature core 212 by first wrapping a coil on the winding holder 220 and subsequently sleeving the winding holder 220 onto the armature core 212. Because the wrapping step for the winding 230 can be independently carried out before the armature core 212 is assembled with other components to form the magnetic modular body 210, the space available for performing the winding step is large, and difficulty in winding of the wire of the winding 230 can be reduced. Further, the winding holder 220 and the winding 230 can be fabricated in modular form to improve production efficiency, and the number of turns of the winding 230 and the winding density of the winding 230 can be increased, thereby enhancing the output power of the axial flux motor of the present disclosure. Alternatively, the winding holder 220 may be dispensed with when the armature core 212 can receive the winding 230 and allow the winding 230 to be wound thereon.

Because reducing difficulty in winding of the wingding 230 is the main purposed of the present disclosure, the magnetic modular body 210 is separable for assembly. As long as the wingding 230 can be independent from the magnetic modular body 210 and can be directly sleeved on a component of the magnetic modular body 210, the main purposed of the present disclosure can be achieved.

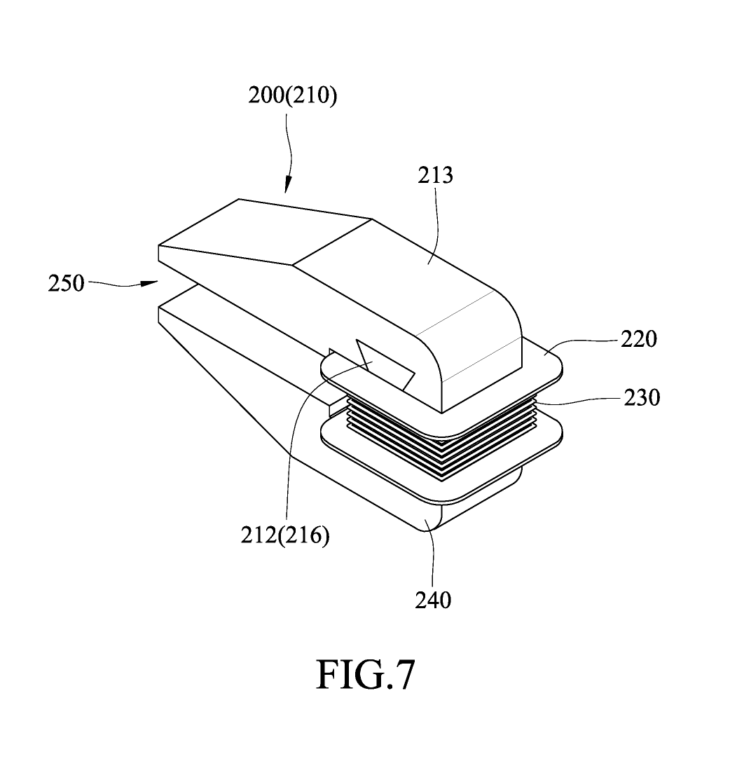

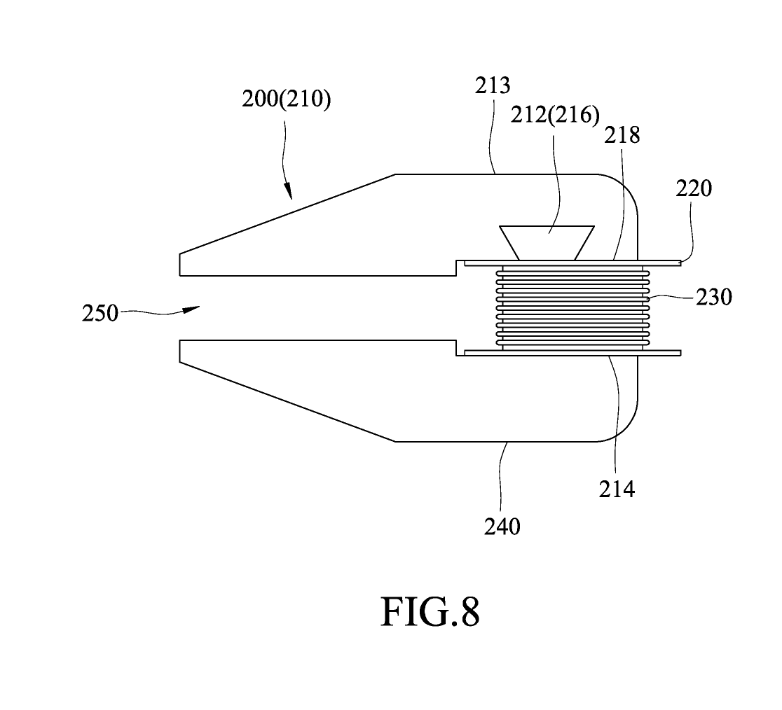

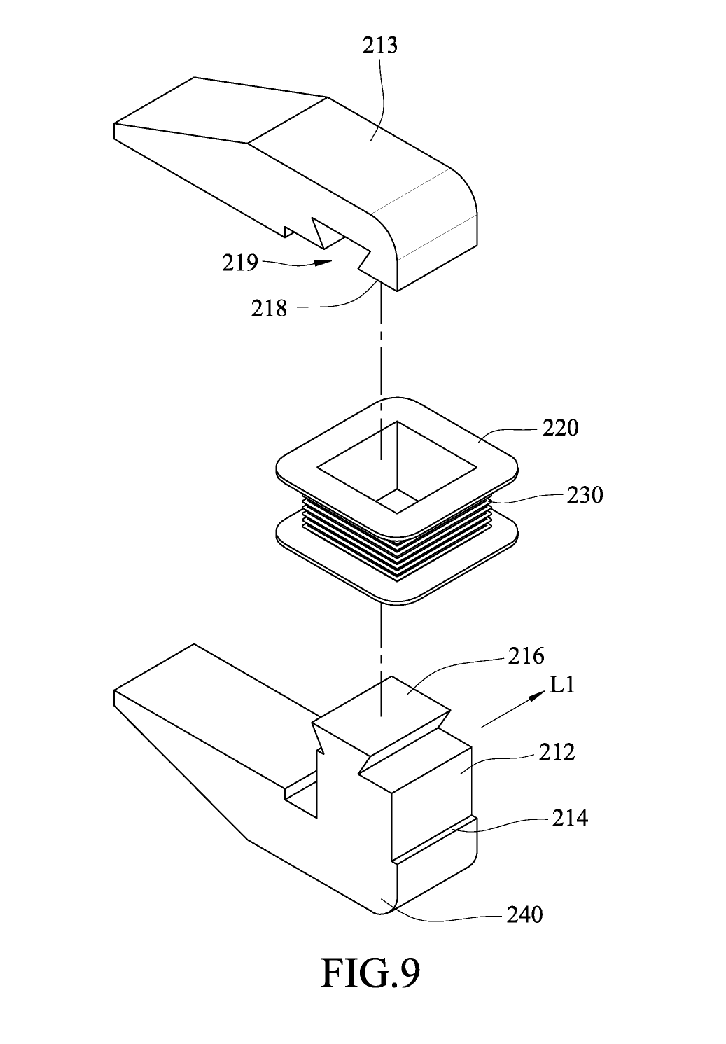

FIGS. 7 to 9 illustrate an axial flux motor according to a second embodiment of the present disclosure. The difference of the second embodiment resides in that the bottom magnetic members 211 and the armature core 212 are integrally formed as one piece so that the magnetic base 240 has a one piece molded structure.

The winding holder 220 together with the winding 230 is directly installed on the magnetic base 240 before the top magnetic member 213 is assembled to the magnetic base 240 to complete assembly of the magnetic modular body 210. By virtue of the one piece structure of the magnetic base 240, assembly of the stator 200 may be facilitated.

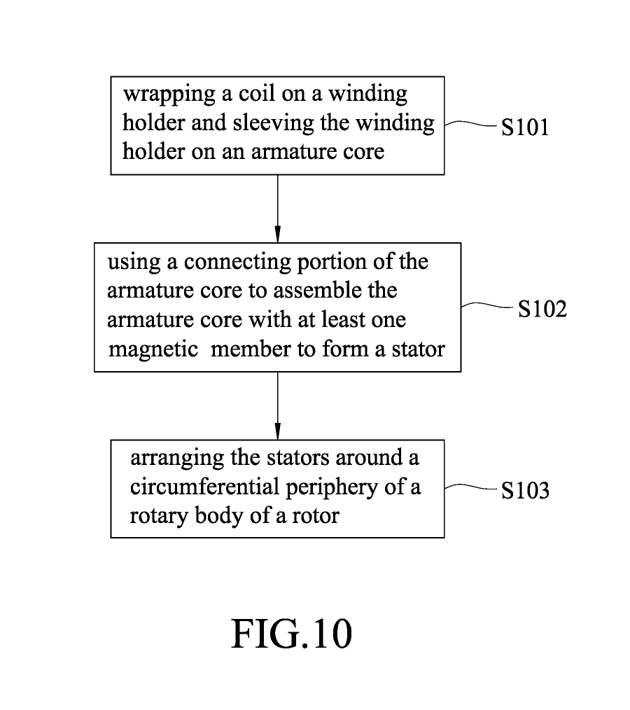

FIG. 10 illustrates a process for assembling the stator according to the pre sent disclosure. The process includes the following steps:

(Step 101) wrapping a coil on a winding holder 220 and sleeving the winding holder 220 on an armature core 212;

(Step 102) using a connecting portion of the armature core 212 to assemble the armature core 212 with at least one magnetic member to form a stator 200; and

(Step 103) repeating steps S101 and S102 to form a plurality of the stators 200, and arranging the stators 200 around a circumferential periphery 111 of a rotary body 110 of a rotor 100.

In Step 102, the number of the connecting portion of the armature core 212 is equal to that of the magnetic member. When the number of the connecting portion of the armature core 212 and the magnetic member is one, the stator 200 is in the form shown in FIGS. 7 to 9. When the armature core 212 has two connecting portions, and when there are two magnetic members, the stator 200 is in the form shown in FIGS. 4 to 6.

In the description above, for the purposes of explanation, numerous specific details have been set forth in order to provide a thorough understanding of the embodiment. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects.

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. An axial flux motor comprising:
a rotor including a rotary body rotatable about an axis; and
a plurality of stators disposed around a circumferential periphery of said rotary body, each of said stators including a magnetic modular body and a winding, said magnetic modular body including a magnetic base and a top magnetic member, said magnetic base having a first magnetic face, an armature core that is disposed on said first magnetic face and that is surrounded by said winding, and a first connecting portion disposed on top of said armature core, said top magnetic member having a second magnetic face, and a second connecting portion that is disposed on said second magnetic face and that engages complementarily to said first connecting portion, said top magnetic member being connected to said armature core through an inter-engagement of said first and second connecting portions, said first and second magnetic faces confronting each other and cooperatively defining a recess to allow said circumferential periphery of said rotary body to pass through when said rotary body rotates about the axis.

2. The axial flux motor as claimed in claim 1, wherein:
said first connecting portion is a trapezoidal tongue that extends along a first direction and that has a trapezoidal cross section which is transverse to said first direction and which is widened upward and narrowed downward; and
said second connecting portion is a trapezoidal groove that extends along the first direction, said first connecting portion being inserted into said second connecting portion along the first direction to interengage each other and to assemble said magnetic base and said top magnetic member.

3. The axial flux motor as claimed in claim 1, wherein each of said magnetic base and said top magnetic member is a magnetic one-piece molded block.

4. The axial flux motor as claimed in claim 1, wherein each of said magnetic base and said top magnetic member is a block composed of a plurality of laminated magnetic plates that are stacked along the first direction.

5. The axial flux motor as claimed in claim 1, wherein said magnetic base further has a bottom magnetic member having a top face formed as said first magnetic face, said armature core being installed on said first magnetic face.

6. The axial flux motor as claimed in claim 5, wherein said magnetic base further has a third connecting portion disposed on bottom of said armature core, said bottom magnetic member having a fourth connecting portion that is disposed on said first magnetic face and that engages complementarily said third connecting portion, said armature core being connected to said bottom magnetic member through an inter-engagement of said third and fourth connecting portions.

7. The axial flux motor as claimed in claim 6, wherein:
said third connecting portion is a trapezoidal tongue that extends along a first direction and that has a trapezoidal cross section which is transverse to the first direction and which is narrowed upward and widened downward; and
said fourth connecting portion is a trapezoidal groove that extends along the first direction, said third connecting portion being inserted into said fourth connecting portion along the first direction to interengage each other and to assemble said armature core on said bottom magnetic member.

8. The axial flux motor as claimed in claim 5, wherein each of said top and bottom magnetic members and said armature core is a magnetic one-piece molded block.

9. The axial flux motor as claimed in claim 5, wherein each of said top and bottom magnetic members and said armature core is a block composed of a plurality of laminated magnetic plates that are stacked along a first direction.

10. The axial flux motor as claimed in claim 1, wherein each of said stators further includes a winding holder sleeved on said armature core, said winding being wound on said winding holder.
